(19) United States
(12) Patent Application Publication
(10) Pub. No.: US 2026/0367446 A1
(43) Pub. Date: Nov. 19, 2026

(54) DISPLAY DEVICE

(71) Applicant: HISENSE VISUAL TECHNOLOGY CO., LTD., Shandong (CN)

(72) Inventors: Zhenhua PANG, Shandong (CN); Chaojie QU, Shandong (CN); Zhiqiang XU, Shandong (CN); Bin LI, Shandong (CN)

(73) Assignee: HISENSE VISUAL TECHNOLOGY CO., LTD., Shandong (CN)

(21) Appl. No.: 19/736,959

(22) Filed: Jul. 10, 2026

Related U.S. Application Data
(63) Continuation of application No. PCT/CN2024/108264, filed on Jul. 29, 2024.

(30) Foreign Application Priority Data
Jan. 10, 2024 (CN) 202420064455.9
Jan. 10, 2024 (CN) 202420598763.X
Jan. 10, 2024 (CN) 202420599358.X

(51) Int. Cl. G02F 1/13357; G02F 1/1335

(52) U.S. Cl. CPC G02F 1/133608; G02F 1/133603; G02F 1/133612

(57) ABSTRACT

A display device, includes a display panel and a backlight module, where the display panel is configured to display an image; and the backlight module is located on a light-incident side of the display panel and is configured to provide backlight. The backlight module comprises a flexible board and an optical element, where the flexible board is provided with a first connecting portion; and the optical element is electrically connected to the flexible board, and the optical element is provided with a second connecting portion corresponding to the first connecting portion, the first connecting portion and the second connecting portion being electrically conducted.

### CROSS-REFERENCE TO RELATED APPLICATION

This application is a continuation application of PCT/CN2024/108264, filed on Jul. 29, 2024, which claims the priority of Chinese Patent Application No. 202420064455.9, filed on Jan. 10, 2024, the priority of Chinese Patent Application No. 202420598763.X, filed on Jan. 10, 2024, and the priority of Chinese Patent Application No. 202420599358.X, filed on Jan. 10, 2024, the entire contents of which are incorporated herein by reference.

### BACKGROUND

### Technical Field

The present disclosure relates to the field of display technology, and in particular, to a display device.

### Description of Related Art

As current mainstream display devices, flat-panel displays, televisions, and the like have advantages such as low power consumption, small size, and low radiation. A display device includes a display panel, and the display panel is a non-self-luminous panel, thus requiring use in conjunction with a backlight module. The backlight module can provide light required for image display to the display panel.

In the related art, a backlight module includes a light strip and an adapter board. The adapter board is connected to a plurality of light strips via adapters. During operation, the adapter board and the light strips generate heat, which may easily cause thermal expansion and contraction of the adapter board, thereby causing a problem of poor connection between the light strips and the adapter board. To avoid the above phenomenon, the size of the connector between the adapter board and the light strips requires a relatively large size margin, which however may easily cause the adapter board to be large in size and high in cost.

### SUMMARY

An embodiment of the present application provides a display device, which may include: a display panel configured for image display; and a backlight module located on a light incident side of the display panel and configured to provide backlighting. The backlight module may include: a flexible board provided with a first connection portion; and an optical element electrically connected to the flexible board. The optical element is provided with a second connection portion corresponding to the first connection portion. The first connection portion and the second connection portion are in electrical conduction.

In some embodiments of the present application, the first connection portion on the flexible board is fixedly connected to the second connection portion on the optical element.

In some embodiments of the present application, the optical element may include a light strip and a terminal connector. The flexible board is electrically connected to the light strip via the terminal connector. The terminal connector may include a support surface and a mounting portion. The support surface is configured to support the flexible board. The second connection portion and the mounting portion are both disposed on the support surface. The mounting portion and the support surface together define a limiting space. One end of the flexible board is passable through the limiting space, and the first connection portion on the flexible board is connected to the second connection portion on the optical element.

In some embodiments of the present application, the backlight module may further include a press plate. The press plate is disposed corresponding to the terminal connector. The flexible board is pressed between the press plate and the terminal connector.

In some embodiments of the present application, the press plate and the terminal connector are separate structures.

In some embodiments of the present application, the press plate may include a flat plate and reinforcing plates. Along a length direction of the flexible board, the reinforcing plates are respectively disposed at two ends of the flat plate. An included angle is formed between the flat plate and each of the reinforcing plates to define an opening facing the terminal connector. A portion of the flexible board and a portion of the terminal connector are located within the opening.

In some embodiments of the present application, the optical element may include a plurality of light strips. The plurality of light strips are arranged side-by-side and spaced apart from each other along the length direction of the flexible board. The mounting portion may include a first limiting portion. Along a thickness direction of the display panel, the flexible board is located between the first limiting portion and the support surface.

In some embodiments of the present application, the mounting portion may further include second limiting portions. Along a length direction of the light strip, the second limiting portions are respectively disposed at two ends of the support surface. Along the thickness direction of the display panel, one end of each of the second limiting portions is connected to the support surface, and another end of each of the second limiting portions is connected to the first limiting portion. Along the length direction of the light strip, a distance between the second limiting portions is greater than or equal to a width of the flexible board. Along the length direction of the light strip, a distance between opposing ends of two first limiting portions is less than the width of the flexible board.

In some embodiments of the present application, a third limiting portion is disposed on one of the flexible board or the terminal connector, and a fourth limiting portion is disposed on another of the flexible board or the terminal connector. The third limiting portion is cooperatively engaged with the fourth limiting portion.

An embodiment of the present application provides a display device, which may include a display panel and a backlight module. The backlight module is disposed on a light incident side of the display panel. The backlight module may include a flexible board and an optical element. The flexible board is provided with a first connection portion. The optical element is provided with a second connection portion corresponding to the first connection portion. The first connection portion and the second connection portion are in electrical conduction.

### BRIEF DESCRIPTION OF THE DRAWINGS

FIG. 1 is a schematic cross-sectional structural view of a display device according to an embodiment of the present application.

FIG. 2 is a schematic exploded structural view of a display device according to an embodiment of the present application.

FIG. 3 is a schematic partial front structural view of a display device according to an embodiment of the present application.

FIG. 4 is a schematic partial exploded structural view of a backlight module according to an embodiment of the present application.

FIG. 5 is a schematic partial front structural view of a backlight module according to an embodiment of the present application.

FIG. 6 is a schematic partial cross-sectional structural view taken along line A-A in FIG. 5

FIG. 7 is a schematic partial exploded structural view of a backlight module according to an embodiment of the present application.

FIG. 8 is a schematic partial cross-sectional structural view taken along line B-B in FIG. 5

FIG. 9 is a schematic exploded structural view of FIG. 8.

FIG. 10 is a schematic structural view of a terminal connector according to an embodiment of the present application.

FIG. 11 is a schematic structural view of a terminal connector according to another embodiment of the present application.

FIG. 12 is an enlarged schematic view of portion C in FIG. 3.

### REFERENCE NUMERALS

10—display device; 100—backlight module; 110—flexible board; 110a—first connection portion; 110b—fourth limiting portion; 111—first board body; 112—second board body; 120—optical element; 120a—second connection portion; 121—light strip; 122—terminal connector; 122a—support surface; 122b—third limiting portion; 122c—limiting space; 1221—mounting portion; 1221a—notch; 12211—first limiting portion; 12212—second limiting portion; 130—press plate; 130a—opening; 131—flat plate; 132—reinforcing plate; 140—backplate; 140a—first through hole; 140b—second through hole; 200—display panel; 300—power supply; 400—main board.

### DESCRIPTION OF THE EMBODIMENTS

Some embodiments of the present disclosure will be described clearly and completely below with reference to the accompanying drawings. Apparently, the described embodiments are merely some, rather than all, of the embodiments of the present disclosure. All other embodiments obtained by a person of ordinary skill in the art based on the embodiments provided in the present disclosure shall fall within the scope of protection of the present disclosure.

Unless the context otherwise requires, throughout the specification and claims, the term “comprise” and its other forms such as the third-person singular form “comprises” and the present participle form “comprising” are to be interpreted as open and inclusive, i.e., “including, but not limited to.” In the description of the specification, the terms “one embodiment”, “some embodiments”, “exemplary embodiments”, “example”, “specific example”, or “some examples” are intended to indicate that a particular feature, structure, material, or characteristic associated with that embodiment or example is included in at least one embodiment or example of the present disclosure. The schematic representations of the above terms do not necessarily refer to the same embodiment or example. Furthermore, the particular features, structures, materials, or characteristics may be included in any suitable manner in any one or more embodiments or examples.

Hereinafter, the terms “first” and “second” are used for description purposes only and shall not be understood as indicating or implying relative importance or implicitly indicating the quantity of the indicated technical features. Thus, a feature defined with “first” or “second” may explicitly or implicitly include one or more of that feature. In the description of the embodiments of the present disclosure, unless otherwise specified, “a plurality of” means two or more.

In describing some embodiments, expressions such as “coupled” and “connected” and their derivatives may be used. The term “connected” should be understood in a broad sense. For example, “connected” may be a fixed connection, a detachable connection, or an integral connection; it may be a direct connection, or an indirect connection through an intermediate medium. The term “coupled” indicates that two or more components have direct physical contact or electrical contact. The term “coupled” or “communicatively coupled” may also refer to two or more components that are not in direct contact with each other but still cooperate or interact with each other. The embodiments disclosed herein are not necessarily limited to the content herein.

“At least one of A, B, and C” has the same meaning as “at least one of A, B, or C” and includes the following combinations of A, B, and C: A only, B only, C only, A and B in combination, A and C in combination, B and C in combination, and A, B, and C in combination. “A and/or B” includes the following three combinations: A only, B only, and A and B in combination.

The use of “adapted to” or “configured to” herein means open and inclusive language that does not exclude devices adapted to or configured to perform additional tasks or steps.

As used herein, “about”, “approximately”, or “substantially” includes the stated value and an average within an acceptable deviation range of the particular value, where the acceptable deviation range is determined by a person of ordinary skill in the art in view of the measurement in question and the error associated with the measurement of the particular quantity (i.e., the limitations of the measurement system).

As used herein, “parallel”, “perpendicular”, and “equal” include the stated case and cases approximating the stated case, the scope of such approximating cases being within an acceptable deviation range, where the acceptable deviation range is determined by a person of ordinary skill in the art in view of the measurement in question and the error associated with the measurement of the particular quantity (i.e., the limitations of the measurement system). For example, “parallel” includes absolute parallel and approximate parallel, where the acceptable deviation range for approximate parallel may be, for example, a deviation within 5°; “perpendicular” includes absolute perpendicular and approximate perpendicular, where the acceptable deviation range for approximate perpendicular may also be, for example, a deviation within 5°. “Equal” includes absolute equal and approximately equal, where the acceptable deviation range for approximately equal may be, for example, a difference between the two being equal to or less than 5% of either one.

Display devices such as flat-panel displays and televisions may be configured to display images. Taking a liquid crystal display (LCD) device as an example, the LCD device is mainly composed of a backlight module, a liquid crystal panel, and a driving circuit. The liquid crystal panel serves as a display panel and does not emit light itself, thus requiring a light source provided by an optical element in the backlight module to achieve brightness display. The imaging principle of a liquid crystal display is to place liquid crystal between two sheets of conductive glass, and to drive an electric field between two electrodes to cause a twisted-nematic electric field effect of liquid crystal molecules, thereby controlling the transmission or shielding function of the back optical element, so as to display an image. If a color filter is added, a color image can be displayed.

In the related art, a backlight module may include a light strip and an adapter board. Each light strip may be connected to an external circuit through a separate connecting wire, and the connection manner is simple. However, each light strip is provided with one connecting wire, and the connecting wires cannot be shared, which may easily cause problems such as a large number of overall circuits, large impedance, and high cost.

Therefore, one adapter board may be connected to each light strip and then to an external circuit to solve the above technical problems. However, the applicant has found that the adapter board is made of a rigid material, and heat generated during operation of the display device may easily cause thermal expansion and contraction of the adapter board, thereby causing a problem of poor connection between the light strips and the adapter board. For example, after the adapter board expands due to heat, it may easily push against the connector on the light strip in a direction away from the adapter board, so as to detach the connector from the adapter board. When the adapter board cools down to room temperature and contracts, it may easily cause the connector on the light strip to separate from the adapter board. To avoid the above phenomenon, the size of the connector between the adapter board and the light strips requires a relatively large size margin, which however may easily cause the adapter board to be large in size and high in cost.

Based on the above technical problems, the applicant has improved the structure of existing display devices. In the present application, a flexible board may be connected to an optical element. The flexible board is a flexible printed circuit board (FPC). The flexible board is a printed circuit supported by a flexible insulating substrate and has good flexibility. After the flexible board is deformed under force, it can maintain the shape under the applied force after the force is removed. Therefore, the flexible board is not easily affected by thermal expansion and contraction, thereby reducing the possibility of poor connection between the optical element and the flexible board.

The display device provided by the present application will be described below with reference to the accompanying drawings and in conjunction with specific embodiments.

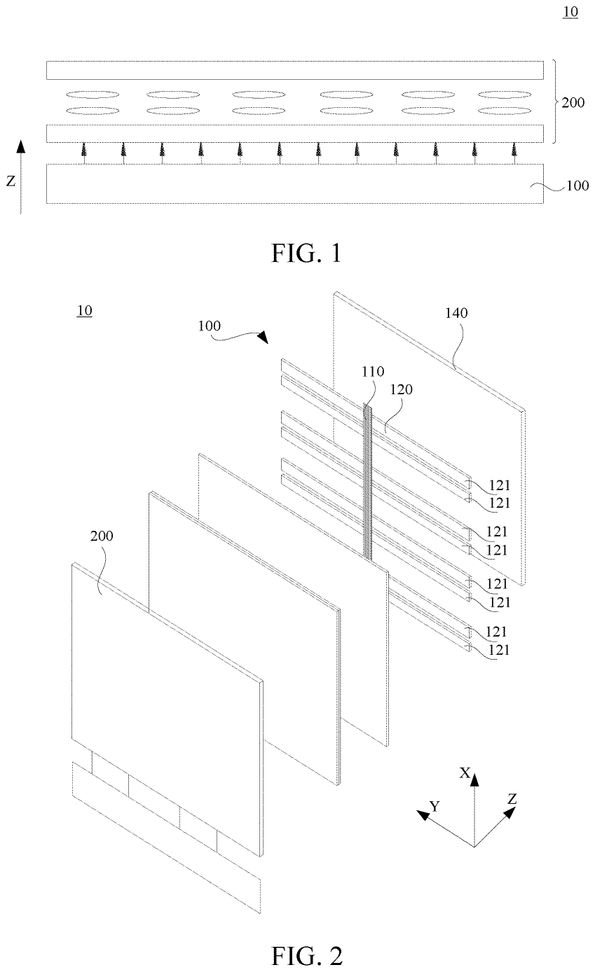

FIG. 1 is a schematic cross-sectional structural view of a display device 10 provided by the present application. FIG. 2 is a schematic exploded structural view of a display device 10 provided by the present application.

Referring to FIGS. 1 and 2, the display device 10 may include a display panel 200 and a backlight module 100. The display panel 200 may be configured for image display. The backlight module 100 may be located on a light incident side of the display panel 200. The backlight module 100 may be configured to provide backlighting to the display panel 200.

The backlight module 100 may include a flexible board 110 and an optical element 120. The flexible board 110 may be provided with a first connection portion 110a. The optical element 120 is electrically connected to the flexible board 110. The optical element 120 may be provided with a second connection portion 120a corresponding to the first connection portion 110a. The first connection portion 110a and the second connection portion 120a are in electrical conduction.

In the embodiment of the present application, the flexible board 110 is connected to the optical element 120, so that the connection reliability between the flexible board 110 and the optical element 120 is not easily affected by thermal expansion and contraction.

Specifically, when heat generated during operation of the display device 10 causes the flexible board 110 to expand, the toughness of the flexible board 110 can weaken the tensile force (expansion force) applied thereto, so that the first connection portion 110a can move synchronously with the deformation of the flexible board 110, and the force of the flexible board 110 on the optical element 120 can cause the second connection portion 120a on the optical element 120 to move synchronously, thereby reducing the possibility of poor connection between the interface on the optical element 120 and the flexible board 110. Similarly, when the display device 10 stops operating, the toughness of the flexible board 110 can also resist the contraction force applied thereto. The first connection portion 110a can move synchronously with the deformation of the flexible board 110, and the force of the flexible board 110 on the optical element 120 can cause the second connection portion 120a on the optical element 120 to move synchronously, thereby reducing the possibility of poor connection between the interface on the optical element 120 and the flexible board 110. Moreover, it is easily understood that when the display device 10 stops operating to cool the flexible board 110, because the flexible board 110 has good flexibility, the flexible board 110 is not prone to contraction that may cause poor contact between the flexible board 110 and the optical element 120.

In some examples, the first connection portion 110a and the second connection portion 120a may be attached to each other to electrically conduct the flexible board 110 and the optical element 120. Alternatively, the first connection portion 110a and the second connection portion 120a may also be electrically conducted through a conductive component. Specifically, both the first connection portion 110a and the second connection portion 120a are electrically conducted with the conductive component. The conductive component can achieve stable connection between the first connection portion 110a and the second connection portion 120a.

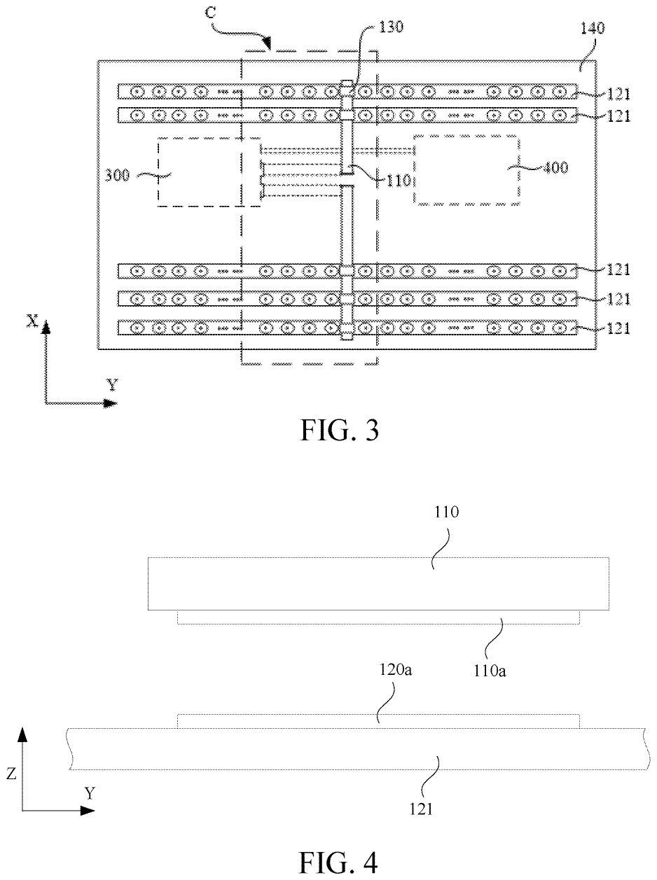

FIG. 3 is a schematic front structural view of a backlight module 100 when a user faces the light exit side of the display panel 200.

In some examples, referring to FIGS. 2 and 3, the backlight module 100 may further include a backplate 140. The backplate 140 may be configured to support components such as the optical element 120, and may also have a heat dissipation function for the optical element 120.

The optical element 120 may be disposed on the backplate 140. Since the backplate 140 has a supporting function, the backplate 140 is prone to deformation. Therefore, when the flexible board 110 in the embodiment of the present application is fixed to the backplate 140, it is not easily affected by the deformation of the backplate 140, which can reduce the phenomenon that deformation of one of the two rigidly connected components affects the connection stability of the two.

In some examples, the backlight module 100 is generally located at the bottom of the display device. The shape and size of the backlight module 100 may be adapted to the shape and size of the display device. For example, when configured in fields such as display devices or mobile terminals, the backlight module 100 generally has a rectangular shape.

For example, when the display panel 200 is rectangular, referring to the orientation shown in FIG. 2, the display panel 200 may include a top side, a bottom side, a left side, and a right side. The top side and the bottom side of the display panel 200 are opposite to each other, and the left side and the right side are opposite to each other. The top side is connected to one end of the left side and one side of the right side, respectively, and the bottom side is connected to the other end of the left side and the other end of the right side, respectively.

In some examples, the backplate 140 may also have a rectangular shape.

In some examples, the display panel 200 may be a transmissive display panel 200, which can modulate the transmittance of light but does not emit light itself. The display panel 200 may have a plurality of pixel units arranged in an array. Each pixel unit can independently control the light transmittance and color of light incident from the backlight module 100 to the pixel unit, so that light transmitted through all pixel units forms the displayed image.

In some implementations, the first connection portion 110a of the flexible board 110 and the second connection portion 120a on the optical element 120 may be fixedly connected.

FIG. 4 is a schematic exploded structural view of the flexible board 110 connected to the optical element 120 in an embodiment provided by the present application. In this case, no additional connector is required to connect the flexible board 110 and the optical element 120.

In some examples, referring to FIG. 4, the first connection portion 110a of the flexible board 110 may be a first pad. The second connection portion 120a on the optical element 120 may be a second pad. Along a thickness direction Z of the display panel 200, the first pad of the flexible board 110 and the second pad on the optical element 120 may be disposed opposite to each other, and the flexible board 110 and the optical element 120 are fixedly connected and electrically conducted through a welding process.

It can be understood that the fixed connection between the flexible board 110 and the optical element 120 can improve the connection stability between the two. Moreover, the flexible board 110 may be provided with only the first pad. The optical element 120 may be provided with only the second pad. The flexible board 110 and the optical element 120 may be directly connected through the first pad and the second pad, thereby saving the cost of providing the terminal connector 122.

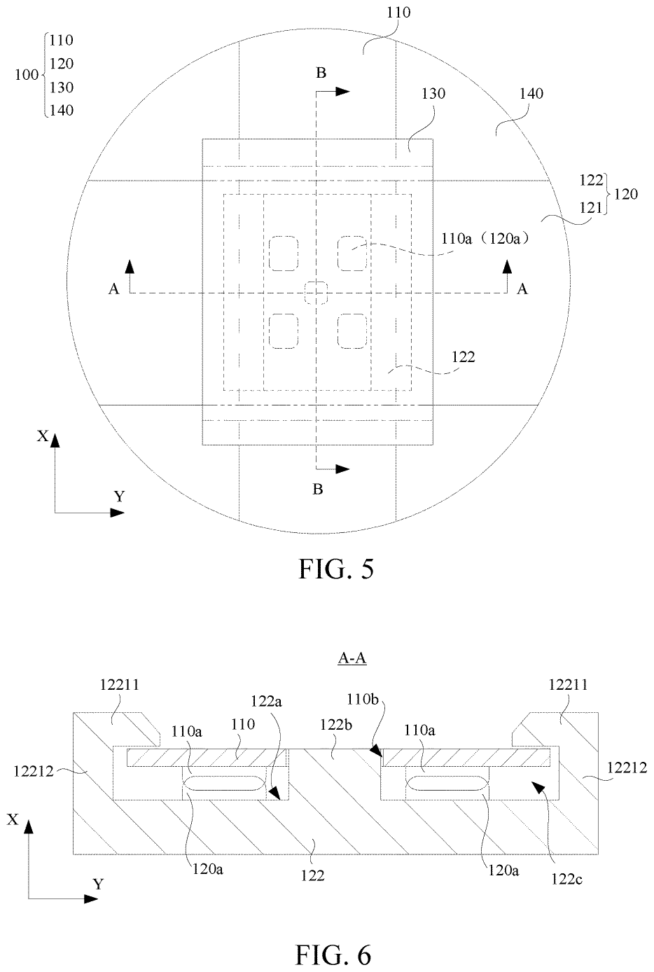

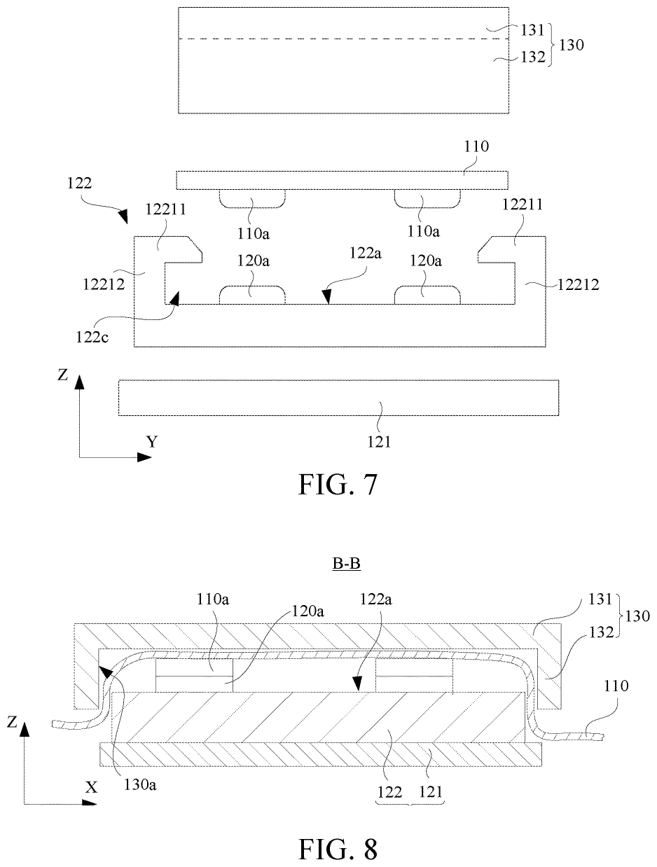

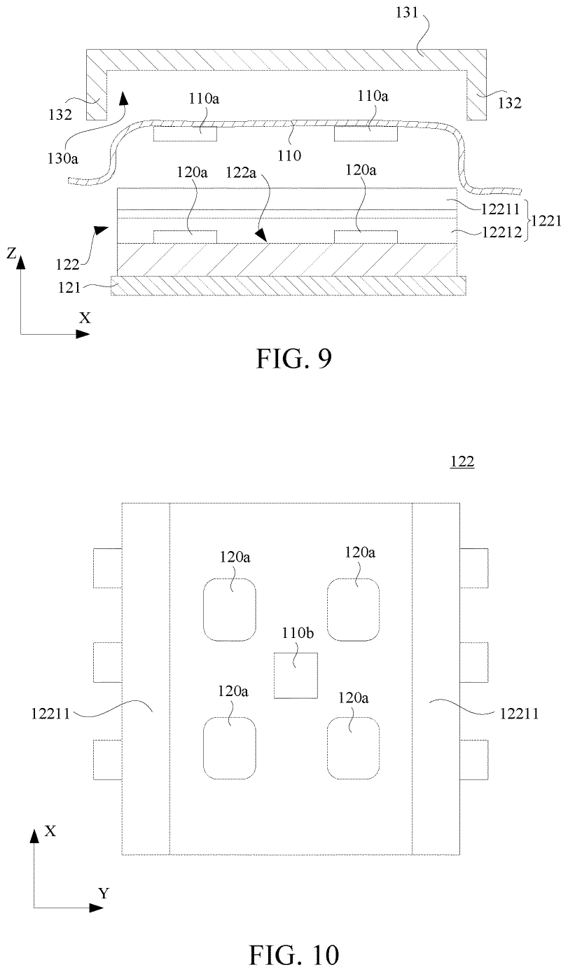

FIG. 5 is a schematic structural view of connection between the flexible board 110 and the optical element 120 in a backlight module 100 provided by the present application. FIG. 6 is a schematic partial cross-sectional structural view taken along line A-A in FIG. 5. FIG. 7 is a schematic partial exploded structural view of the backlight module 100 at the same viewing angle as FIG. 6. FIG. 8 is a schematic partial cross-sectional structural view taken along line B-B in FIG. 5, where the direction A-A is perpendicular to the direction B-B. FIG. 9 is a schematic partial exploded structural view of the backlight module 100 at the same viewing angle as FIG. 8.

In some implementations, referring to FIGS. 5 to 9, the optical element 120 may include a light strip 121 and a terminal connector 122. The flexible board 110 may be electrically connected to the light strip 121 via the terminal connector 122.

Referring to FIGS. 6 and 7, the terminal connector 122 may include a support surface 122a and a mounting portion 1221. The support surface 122a may be configured to support the flexible board 110. The second connection portion 120a and the mounting portion 1221 are both disposed on the support surface 122a. The mounting portion 1221 and the support surface 122a together define a limiting space 122c. One end of the flexible board 110 is passable through the limiting space 122c, and the first connection portion 110a on the flexible board 110 is connected to the second connection portion 120a on the optical element 120.

In the embodiment of the present application, the support surface 122a is provided with the second connection portion 120a on a surface facing the flexible board 110. The mounting portion 1221 can constrain the flexible board 110 within the limiting space 122c, so as to reduce the possibility that the flexible board 110 undergoes large displacement under force, thereby affecting the connection stability between the flexible board 110 and the terminal connector 122. When the flexible board 110 is located in the limiting space 122c, the first connection portion 110a on the flexible board 110 corresponds to the second connection portion 120a. When the first connection portion 110a and the second connection portion 120a are connected, the flexible board 110 and the light strip 121 are electrically conducted.

The mounting portion 1221 in the embodiment of the present application may be configured to constrain movement of the flexible board 110 on the support surface 122a. The mounting portion 1221 may be fixed on the support surface 122a, detachably connected to the support surface 122a, or movably connected to the support surface 122a, which is not limited in the present application.

For example, when the flexible board 110 is placed on the support surface 122a, the mounting portion 1221 may abut against a surface of the flexible board 110 facing away from the first connection portion 110a, so that the first connection portion 110a and the second connection portion 120a can be closely attached.

In some examples, the first connection portion 110a of the flexible board 110 may be a first contact. The second connection portion 120a on the terminal connector 122 may be a second contact. The connection between the first contact and the second contact can electrically connect the flexible board 110 and the light strip 121.

In some examples, a light board or light strips 121 are generally used to provide backlighting to the display panel 200. In the embodiment of the present application, the light strips 121 may be used to provide backlighting to the display panel 200. It is easily understood that the area of a light board is much larger than that of a light strip 121, thus easily causing an increase in cost. In the embodiment of the present application, the number of light strips 121 may be a plurality, and the plurality of light strips 121 may be arranged in parallel on the backplate 140 to achieve the same effect as a light board.

In some examples, each light strip 121 may be provided with one terminal connector 122. The flexible board 110 may be provided with a plurality of first connection portions 110a. One end of the flexible board 110 may sequentially pass through the limiting spaces 122c of the terminal connectors 122 on the plurality of light strips 121, so that each first connection portion 110a is electrically conducted with the first connection portion 110a on the terminal connector 122 on each light strip 121 after being aligned.

In some implementations, referring to FIGS. 8 and 9, the backlight module 100 may further include a press plate 130. The press plate 130 and the terminal connector 122 may be disposed correspondingly. The flexible board 110 may be pressed between the press plate 130 and the terminal connector 122.

In the embodiment of the present application, along a thickness direction Z of the display panel 200, the press plate 130 may be located on a side of the terminal connector 122 facing the flexible board 110. An inner wall surface of the press plate 130 may be attached to the flexible board 110. The inner wall surface of the press plate 130 may refer to a surface of the press plate 130 facing the terminal connector 122.

When the flexible board 110 is pulled by an external force, the attachment between the inner wall surface of the press plate 130 and the flexible board 110 can increase the friction force between the press plate 130 and the flexible board 110, thereby reducing the possibility that the flexible board 110 is displaced under force, which would affect the connection stability between the flexible board 110 and the terminal connector 122, through the friction force between the press plate 130 and the flexible board 110.

Specifically, referring to FIG. 8, when the flexible board 110 is subjected to a pulling force along its length direction X, since the press plate 130 and the flexible board 110 can be closely connected, the friction force between the mutually opposing surfaces of the press plate 130 and the flexible board 110 can resist displacement of the flexible board 110, thereby effectively reducing the possibility of poor connection between the flexible board 110 and the terminal connector 122 due to offset of the flexible board 110.

In addition, the press plate 130 may also have a protective function. The press plate 130 can cover the first connection portion 110a and the second connection portion 120a to protect the first connection portion 110a and the second connection portion 120a from external impact forces, thereby improving the connection stability between the flexible board 110 and the optical element 120.

In some examples, the press plate 130 and the terminal connector 122 may be an integral structure. For example, the press plate 130 may be movably connected to the terminal connector 122 to save assembly processes. Alternatively, the press plate 130 and the terminal connector 122 may also be separate structures, and the press plate 130 may be tightly connected to the terminal connector 122 under external force, so that the flexible board 110 can be pressed between the press plate 130 and the terminal connector 122, which is not limited in this embodiment.

In some implementations, as shown in FIG. 8, the press plate 130 and the terminal connector 122 in this embodiment may be separate structures.

During production and assembly of the optical element 120, the terminal connector 122 needs to be quality inspected to avoid affecting the factory yield of the display device 10. If the press plate 130 and the terminal connector 122 are an integral structure, during inspection, the press plate 130 needs to be opened to expose the terminal connector 122 for inspection, and after inspection, the press plate 130 needs to be closed, which may easily make the quality inspection process cumbersome and complicated, and is also not conducive to automated operations. Therefore, in this embodiment, the press plate 130 and the terminal connector 122 may be designed as separate structures to facilitate quality inspection of the optical element 120. After passing the quality inspection, the flexible board 110 may be installed, and the flexible board 110 is fixed between the press plate 130 and the terminal connector 122 by the press plate 130, and the first connection portion 110a and the second connection portion 120a are electrically conducted.

In the embodiment of the present application, after the first connection portion 110a of the flexible board 110 is connected to the second connection portion 120a of the terminal connector 122, the press plate 130 can press the flexible board 110 between the press plate 130 and the terminal connector 122, so as to reduce the possibility that when a welding process is used to fix the press plate 130 and the flexible board 110, the press plate 130 needs to have good high-temperature resistance, and the material requirements for the press plate 130 are high, thus causing an overall increase in cost.

In some implementations, referring to FIGS. 8 and 9, the press plate 130 in the embodiment of the present application may include a flat plate 131 and reinforcing plates 132. Along a length direction X of the flexible board, the reinforcing plates 132 are respectively disposed at two ends of the flat plate 131. An included angle may be formed between the flat plate 131 and each of the reinforcing plates 132. The flat plate 131 and the reinforcing plates 132 may form an opening 130a facing the terminal connector 122. A portion of the flexible board 110 and a portion of the terminal connector 122 may be located within the opening 130a, and the first connection portion 110a and the second connection portion 120a may be located within the opening 130a. The first connection portion 110a and the second connection portion 120a may be electrically connected at the opening 130a.

Surfaces of the reinforcing plates 132 and the flat plate 131 facing the terminal connector 122 may both be in contact with the flexible board 110, thereby increasing the contact area between the press plate 130 and the flexible board 110, which is beneficial to increasing the friction force generated between the press plate 130 and the flexible board 110 when the flexible board 110 is subjected to a pulling force, thereby more effectively improving the stability of the flexible board 110 and the press plate 130.

In some examples, the included angle between each of the reinforcing plates 132 and the flat plate 131 may be a right angle.

In some implementations, referring to FIGS. 2 and 3, the optical element 120 may include a plurality of light strips 121. The plurality of light strips 121 may be arranged side-by-side and spaced apart from each other along the length direction X of the flexible board. The flexible board 110 may be electrically connected to each of the plurality of light strips 121. The mounting portion 1221 may include a first limiting portion 12211. Along the thickness direction Z of the display panel, the flexible board 110 may be located between the first limiting portion 12211 and the support surface 122a.

Referring to FIG. 8, along the thickness direction Z of the display panel, a distance between the first limiting portion 12211 and the support surface 122a may be greater than or equal to a thickness of the flexible board 110. When the flexible board 110 is located in the limiting space 122c, the first limiting portion 12211 can prevent the flexible board 110 from coming out of the limiting space 122c along the thickness direction Z of the display panel, thereby positioning the flexible board 110 in the thickness direction Z of the display panel.

In some examples, when the distance between the first limiting portion 12211 and the support surface 122a is greater than the thickness of the flexible board 110, the distance between the first limiting portion 12211 and the support surface 122a may satisfy the installation tolerance of the flexible board 110, so as to prevent the distance between the first limiting portion 12211 and the support surface 122a from being too large, which would cause the limiting effect of the first limiting portion 12211 to fail.

In some examples, referring to the orientation shown in FIG. 3, the light strips 121 may be placed horizontally. The terminal connector 122 may be disposed in a middle region of the light strip 121. The plurality of light strips 121 are spaced apart from each other in a vertical direction (the length direction X of the flexible board). The length direction X of the flexible board and a length direction Y of the light strips intersect at an included angle. For example, the length direction X of the flexible board and the length direction Y of the light strips may be perpendicular to each other.

FIG. 10 is a schematic structural view of a terminal connector 122 provided by the present application.

In some implementations, referring to FIGS. 6 and 7, the mounting portion 1221 may further include second limiting portions 12212. Along the length direction Y of the light strip, the second limiting portions 12212 may be respectively disposed at two ends of the support surface 122a. Along the thickness direction Z of the display panel, one end of each of the second limiting portions 12212 is connected to the support surface 122a, and another end of each of the second limiting portions 12212 may be connected to the first limiting portion 12211.

In the embodiment of the present application, the second limiting portions 12212 can constrain the flexible board 110 from displacing along the length direction Y of the light strips. Along the length direction Y of the light strips, a distance between the second limiting portions 12212 may be greater than or equal to the width of the flexible board 110. Mutually opposing surfaces of the two second limiting portions 12212 and the support surface 122a may define the limiting space 122c. The two second limiting portions 12212 can prevent the flexible board 110 from undergoing large displacement along the length direction Y of the light strips.

A gap between the two first limiting portions 12211 along the length direction Y of the light strips can facilitate installation and removal of the flexible board 110. A distance between opposing ends of the two first limiting portions 12211 may be less than the width of the flexible board 110, so that the flexible board 110 is not easily pulled out from between the two first limiting portions 12211, thereby limiting the flexible board 110 in the thickness direction Z of the display panel.

In some examples, the first limiting portion 12211 and the support surface 122a may be disposed in parallel. The second limiting portion 12212 may be a flat plate structure to connect the first limiting portion 12211 and the support surface 122a. The first limiting portion 12211 may be provided with a chamfer to prevent sharp corners on the first limiting portion 12211 from scratching the flexible board 110 or the staff during installation.

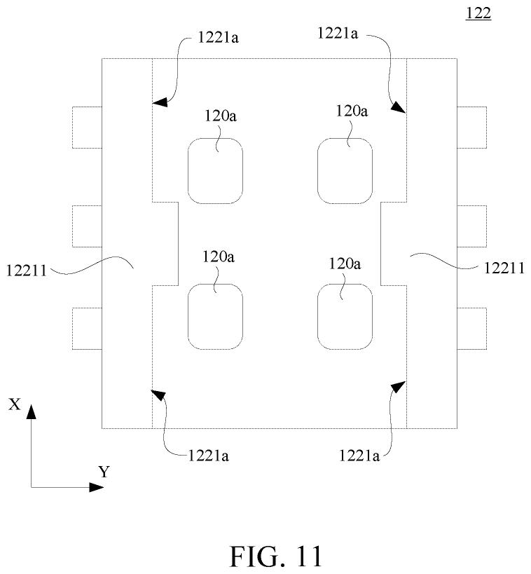

FIG. 11 is a schematic structural view of a terminal connector 122 according to another embodiment of the present application.

In some examples, referring to FIG. 11, the first limiting portion 12211 may be provided with a notch 1221a. The notch 1221a can facilitate adjustment of the installation position of the flexible board 110 to improve assembly efficiency. The notch 1221a may be disposed on mutually opposing surfaces of the two first limiting portions 12211 and extend in a direction toward the second limiting portion 12212.

In some examples, the support surface 122a may have a square shape. Along the length direction Y of the light strips, the second limiting portions 12212 are disposed on two opposite side edges of the support surface 122a. Each of the second limiting portions 12212 may be a plate body having wall thickness.

In some examples, when the second connection portion 120a is a second contact, a soldering lug may be formed on the terminal connector 122.

For example, along the length direction Y of the light strips, two rows of soldering lugs may be formed to form a plurality of pins. For example, each row of soldering lugs may have two or three soldering lugs along the length direction X of the flexible board, i.e., forming 4 pins or 6 pins. FIGS. 10 and 11 show 6 pins. It should be noted that the number of pins is not limited to 4 or 6.

In some implementations, referring to FIGS. 6 and 10, a third limiting portion 122b may be disposed on one of the flexible board 110 or the terminal connector 122, and a fourth limiting portion 110b may be disposed on another of the flexible board 110 or the terminal connector 122. The third limiting portion 122b is cooperatively engaged with the fourth limiting portion 110b.

In the embodiment of the present application, the cooperative engagement between the third limiting portion 122b and the fourth limiting portion 110b can make it difficult for the flexible board 110 to move relative to the terminal connector 122 along the length direction X of the flexible board and along the length direction Y of the light strips, thereby limiting the flexible board 110 on the support surface 122a. Moreover, the cooperative engagement between the third limiting portion 122b and the fourth limiting portion 110b, together with the first limiting portion 12211, can be configured to keep the flexible board 110 within the limiting space 122c, thereby improving the connection reliability between the first connection portion 110a and the second connection portion 120a.

In some examples, the third limiting portion 122b may be a protrusion structure. The fourth limiting portion 110b may be a groove or a hole structure. The support surface 122a of the terminal connector 122 may be provided with the third limiting portion 122b, and correspondingly, the flexible board 110 may be provided with the fourth limiting portion 110b; alternatively, the support surface 122a of the terminal connector 122 may be provided with the fourth limiting portion 110b, and correspondingly, the flexible board 110 may be provided with the third limiting portion 122b. When the third limiting portion 122b is located in the fourth limiting portion 110b, an inner wall of the fourth limiting portion 110b may be configured to constrain displacement of the third limiting portion 122b.

For example, the shapes and sizes of the third limiting portion 122b and the fourth limiting portion 110b may match each other.

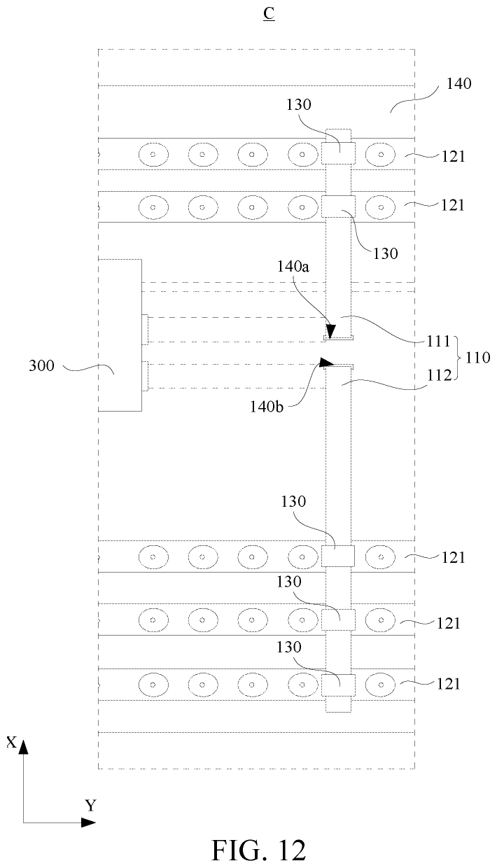

FIG. 12 is an enlarged schematic view of portion C in FIG. 3.

In some implementations, referring to FIGS. 3 and 12, the flexible board 110 may include a first board body 111 and a second board body 112. Along a length direction of the first board body (i.e., the length direction X of the flexible board 110), the first board body 111 and the second board body 112 may be arranged side by side. The first board body 111 may be electrically connected to some of the light strips 121. The second board body 112 may be electrically connected to the remaining light strips 121. The backlight module 100 may further include a backplate 140. The optical element 120 may be disposed on the backplate 140. The backplate 140 may be provided with a first through hole 140a and a second through hole 140b. The first board body 111 may pass through the first through hole 140a to connect to a power supply 300. The second board body 112 may pass through the second through hole 140b to connect to the power supply 300.

In some examples, an end of the first board body 111 connected to the power supply 300 may be provided with a plug. The first board body 111 may be directly connected to the power supply 300 through the plug, without requiring connection through other connector structures. An end of the second board body 112 connected to the power supply 300 may also be provided with a plug. The second board body 112 may be directly connected to the power supply 300 through the plug, which has high connection reliability.

In some examples, the power supply 300 and a main board 400 may be electrically connected through a connecting wire.

In some examples, the plugs on the ends of the first board body 111 and the second board body 112 may be FFC (Flexible Flat Cable) plugs.

In some examples, the number of the first board bodies 111 may be a plurality. When applied to a display device 10 of a relatively large size, a plurality of first board bodies 111 of a relatively small length may be respectively electrically connected to the light strips 121, so as to reduce the possibility that using a flexible board 110 of a relatively long length leads to an overall cost increase of the display device 10.

When the number of the first board bodies 111 is a plurality, the sizes of the plurality of first board bodies 111 may not be completely identical.

Similarly, the number of the second board bodies 112 may also be a plurality. The lengths of the second board bodies 112 and the first board bodies 111 may be different. Furthermore, when the number of the second board bodies 112 is a plurality, the sizes of the plurality of second board bodies 112 may not be completely identical.

It should be noted that any one technical disclosure in the present disclosure may, to a certain extent, solve one or more of the above technical problems and achieve certain inventive objectives; alternatively, a plurality of technical disclosures may be combined into an overall solution to solve one or more of the above technical problems and achieve certain inventive objectives; alternatively, some technical disclosures may be selected and combined into an overall solution, while adopting related technologies and inferior solutions, but the declining trend can be compensated by the technical disclosure means of the present application, thereby as a whole solving one or more of the above technical problems and achieving certain inventive objectives to a certain extent; each combination of technical disclosures into a complete embodiment constitutes an organic and inseparable overall solution, solving technical problems and achieving certain inventive objectives as a whole.

Any one technical disclosure in the present disclosure, as well as recombinations of a plurality of technical disclosures, can form complete embodiments, and can solve one or more of the above plurality of technical problems and achieve the inventive objectives, all of which fall within the content of the present disclosure, and are contents directly and unambiguously determined according to the content of the present disclosure.

It will be appreciated by those skilled in the art that the scope of disclosure of the present invention is not limited to the above specific embodiments, and that certain elements of the embodiments may be modified and substituted without departing from the spirit of the present application. The scope of the present application is defined by the appended claims.

What is claimed is:

1. A display device, comprising:
a display panel; and
a backlight module, located on a light incident side of the display panel and configured to provide backlighting;
wherein the backlight module comprises:
a flexible board, provided with a first connection portion; and
an optical element, electrically connected to the flexible board and provided with a second connection portion corresponding to the first connection portion, wherein the first connection portion is in electrical conduction with the second connection portion.

2. The display device according to claim 1, wherein: the first connection portion on the flexible board is fixedly connected to the second connection portion on the optical element.

3. The display device according to claim 1, wherein: the optical element comprises a terminal connector; wherein the terminal connector is provided with a limiting space, and a portion of the flexible board is located within the limiting space to bring the first connecting portion into electrical conduction with the second connecting portion.

4. The display device according to claim 1, wherein: the optical element comprises a light strip and a terminal connector, wherein the flexible board is electrically connected to the light strip via the terminal connector; and
the terminal connector comprises a support surface and a mounting portion, wherein the support surface is configured to support the flexible board, the second connecting portion and the mounting portion are both disposed on the support surface, the mounting portion and the support surface together define a limiting space, one end of the flexible board is passed through the limiting space, and the first connecting portion on the flexible board is connected to the second connecting portion on the optical element.

5. The display device according to claim 4, wherein: the backlight module further comprises a press plate, wherein the press plate is disposed corresponding to the terminal connector, and the flexible board is pressed between the press plate and the terminal connector.

6. The display device according to claim 5, wherein: the press plate and the terminal connector are separate structures.

7. The display device according to claim 5, wherein: the press plate comprises a flat plate and reinforcing plates;
wherein, along a length direction of the flexible board, the reinforcing plates are respectively disposed at two ends of the flat plate, an included angle is formed between the flat plate and each of the reinforcing plates to define an opening facing the terminal connector, and a portion of the flexible board and a portion of the terminal connector are located within the opening.

8. The display device according to claim 4, wherein: the optical element comprises a plurality of light strips, wherein, along a length direction of the flexible board, the plurality of light strips are arranged side-by-side and are spaced apart from each other; and
the mounting portion comprises a first limiting portion, wherein, along a thickness direction of the display panel, the flexible board is located between the first limiting portion and the support surface.

9. The display device according to claim 8, wherein: the mounting portion further comprises second limiting portions;
wherein, along a length direction of the light strip, the second limiting portions are respectively disposed at two ends of the support surface; and along the thickness direction of the display panel, one end of the second limiting portion is connected to the support surface, and another end of the second limiting portion is connected to the first limiting portion.

10. The display device according to claim 9, wherein: along the length direction of the light strip, a distance between the second limiting portions is greater than or equal to a width of the flexible board; and
along the length direction of the light strip, a distance between opposing ends of two first limiting portions is less than the width of the flexible board.

11. The display device according to claim 8, wherein: a third limiting portion is disposed on one of the flexible board or the terminal connector, and a fourth limiting portion is disposed on another of the flexible board or the terminal connector, wherein the third limiting portion is cooperatively engaged with the fourth limiting portion.

12. The display device according to claim 7, wherein: along a thickness direction of the display panel, the opening of the press plate is disposed opposite to the limiting space, and the first connecting portion and the second connecting portion are located within the opening and the limiting space.

13. The display device according to claim 5, wherein: the press plate and the terminal connector are an integral structure.

14. The display device according to claim 4, wherein: along a length direction of the light strip, the mounting portion comprises two first limiting portions spaced apart from each other; wherein the first limiting portions are provided with notches, wherein the notches are located on surfaces of the two first limiting portions facing each other, and the notch of one of the two first limiting portions extends in a direction away from another of the two first limiting portions.

15. The display device according to claim 4, wherein: the optical element comprises a plurality of light strips, wherein, along a length direction of the flexible board, the plurality of light strips are arranged side-by-side and are spaced apart from each other; and
the flexible board is provided with a plurality of first connecting portions spaced apart from each other, the flexible board is passed through the limiting spaces of the terminal connectors of the plurality of light strips, and the first connecting portions are connected one-to-one with the second connecting portions of the terminal connectors.

16. The display device according to claim 1, wherein: the backlight module further comprises a backplate, wherein a portion of the flexible board is located on a side of the backplate facing the display panel, and one end of the flexible board is passed through the backplate and is connected to a power supply.

17. The display device according to claim 1, wherein: the flexible board comprises a first board body and a second board body, wherein the first board body and the second board body are each provided with a plurality of first connecting portions;
the optical element comprises a plurality of light strips and terminal connectors, wherein the terminal connectors are disposed on the light strips, the first board body is electrically connected to terminal connectors on some of the light strips, and the second board body is electrically connected to terminal connectors on some others of the light strips;
the terminal connectors are provided with second connection portions corresponding to the first connection portions, and the second connection portions are in electrical conduction with the first connection portions.

18. The display device according to claim 8, wherein: the first limiting portion and the support surface are disposed in parallel.

19. The display device according to claim 11, wherein: the third limiting portion is a protrusion structure, and the fourth limiting portion is a groove or a hole structure.

20. The display device according to claim 1, wherein: the first connection portion is a first pad, and the second connection portion is a second pad.
